(19) United States
(12) Patent Application Publication
(10) Pub. No.: US 2005/0200455 A1
(43) Pub. Date: Sep. 15, 2005

(54) Paging system for queue management

(76) Inventors: Salvatore Veni III, Dacula, GA (US); Russell Edwin Ford, Atlanta, GA (US)

Correspondence Address: Brian M. Berliner;O'MELVENY & MYERS LLP, 400 South Hope Street, Los Angeles, CA, 90071-2899, US

(21) Appl. No.: 11/038,736

(22) Filed: Jan. 18, 2005

Related U.S. Application Data
(60) Provisional application No. 60/537,162, filed on Jan. 16, 2004.

(51) Int. Cl. H04Q 7/00

(52) U.S. Cl. 340/7.55; 340/286.09; 340/7.23; 705/15

(57) ABSTRACT

A pager or other wireless communication device is used to keep participants of a queue informed of remaining wait time. An estimate of wait time is generated by a host management application using information concerning availability of a resource, for example, restaurant tables. The wait time is transmitted to each respective pager within the transmitting range of a base station. For positions high in the queue, a chit bearing an estimated return time may be issued in lieu of a pager. The chit may be returned in exchange for a pager after the return time has passed. Advertising messages may also be transmitted to the pagers, and one or more games may be played using the pagers. Pagers may be at least partially disabled when out of range of a transmitter base station.

### CROSS-REFERENCE TO RELATED APPLICATION

This application claims priority pursuant to 35 U.S.C. § 119(e) to U.S. Provisional Application No. 60/537,162, filed Jan. 16, 2004, which application is specifically incorporated herein, in its entirety, by reference.

### BACKGROUND OF THE INVENTION

1. Field of the Invention

The present invention relates to alpha-numeric paging systems, and more particularly, to paging systems such as used to inform participants that have reached the head of a queue.

2. Description of Related Art

Various resources may be provided to the public on a “first-come, first-served” or “walk-in” basis. For example, restaurant services are frequently rendered on this basis. At times of peak demand, a queue may formed to distribute such services to those waiting, in the order of their arrival. Such queue may comprise a waiting list, or a physical line. Either way, traditional queues require that participants remain grouped in the same general area, either to maintain their place in line or to remain within earshot of a loudspeaker or close enough to see a queue board. Because such grouping may sometimes be undesirable, some service establishments have more recently begun to issue pagers to queue participants. Each pager can be commanded to signal its participant using a tactile, auditory, or visual signal when the participant has reached the head of the queue. After being issued a pager, the queue participants are therefore permitted to disperse over a wider area than had previously been possible.

Some prior-art pagers are called “coasters” because, in addition to their function as an electronic pager, they are configured and useable for holding a glass of beverage. It is anticipated and generally desirable for restaurant queue participants to purchase a beverage and wait in an adjoining bar. Paging “coasters” are designed to encourage and to facilitate this behavior. Such pagers are also generally compact, smooth, rugged, and easily carried in a typical pocket or purse.

Notwithstanding their advantages, prior-art paging systems for queue participants are subject to certain limitations. In particular, pagers for such prior-art systems are limited in the functions that they can perform. These functions may be limited, for example, to signaling participants when it is time to return to the service area, providing an out-of-range signal, a low-battery signal, and an auto-locate signal. Prior-art systems are limited, however, in the amount and type of information that is conveyed to queue participants using the pager and associated paging system. For example, there is presently no system for providing systematic estimates of wait times to queue participates using a paging system. Queue participants sometimes becomes impatient for their turn in the queue, and leave the area without intending to return. Not only does this cause a loss of prospective business for the host, it sometimes results in the loss of a pager. The limitations of prior-art pagers and paging systems do not adequately discourage such behavior. It is desirable, therefore, to provide a pager and associated paging system for queue participants, that overcomes these and other limitations of the prior art.

### SUMMARY OF THE INVENTION

The present invention provides a pager and paging system that overcome the limitations of the prior art. Specifically, a paging system according to the invention includes a plurality of pagers, each of which includes a display screen, a keypad, and a controller, in addition to conventional features of pagers for queuing systems. The controller may be connected to sense key presses of the pager keypad and to control the display screen of the pager. The controller may further be connected to receive information from a transmitter station for the pager system. Optionally, the controller may be connected to send or receive information via one or more ports, including but not limited to wired serial connections or wireless ports. In addition, or in the alternative, the pager may further include a transceiver for transmitting information to a central paging station and/or to other remotely-located elements of the system, including to other pagers.

In an embodiment of the invention, a paging system further comprises a host management system. The host management system tracks the availability of resources at a service establishment, and provides an estimated wait time for each position in the queue, based on the facts known to the management system. For example, for a restaurant application, the host management system may comprise a database of tables in the restaurant. The system may be further connected to receive information concerning when each party is seated at a table, when a food order is taken, when food is served, when a check is presented, and when it is paid, along with other relevant information such as table reservations or the number of servers available. An algorithm may be applied by the host management system to estimate future times at which additional resources will become available. From this estimate, the host system may estimate a wait time for each position in the queue, based on the amount of resources each queue participant is requesting. For example, in a restaurant, a party of eight people may not be seated as quickly as a party of two.

The host management system periodically communicates the estimated wait time to a paging host terminal. The paging terminal may then transmit the estimate to each pager that is checked out to a queue participant. Each pager may receive the estimated wait time, and display it on the pager display. For example, the pager may display the most recent estimated wait time using a scrolling text display. If the estimated wait time changes significantly, the host management system and/or paging host terminal may be configured to send a message of the new estimate, optionally with a message of apology for the change.

In addition, or in the alternative, the pager controller may be connected to a programmable memory located in the pager. The memory may contain instructions for providing a game to the user of the pager. Optionally, the memory may be reprogrammed via a port that is regularly connected to the pager, such as during routine battery charging. The controller may further be configured to accept a keystroke or combination of keystrokes from its connected keypad as a signal that a user would like to play a game or games located in its memory. In an embodiment of the invention, the pager may be configured to disable the game function when the pager is taken out of range of the host stand.

The game may be of any suitable type for a portable game-playing device. However, it may be advantageous to limit the resource requirements for the game play, so as to keep the costs of the paging device to a minimal level. Various engaging games can be played using a simple alpha-numeric display and keypad. Such games may include, for example, trivia games. In a trivia game, a participant is provided with a question, followed by two or more (e.g., four) alternative answers. The player is challenged to select the correct answer from among the provided alternatives. These games can be scored by keeping track of the number of correct answers and the total number of questions asked. Optionally, the amount of time required to obtain a given score may also be tracked. Various trivia games are available for specific service contexts, for example, sports trivia games may be of interest to those attending a sports bar. Any other desired type of game, including but not limited to word puzzles, board games or arcade-style games, may also be configured for play using the pager.

A queue participant may thereby be provided an option to participate in a game while waiting for the desired service. The display may also be used for messages from the host of the paging system; for example, advertising and estimated remaining wait time messages that may be provided and transmitted automatically by a host server application. The effectiveness of such messaging may be enhanced while a queue participant is engaged in game play, and is therefore viewing the display screen for the pager. Advertising messages, or other messages controlled by the host of the paging system, may be displayed concurrently with the game display. For example, messages may be scrolled along a top or bottom line of the display, while other lines of the display are used for game play. In the alternative, such messages may be displayed on any line of the display, without an associated game, as described above.

Whatever form of game is played, games may optionally be scored using the on-board controller or other connected controller. The pager may be configured so that the queue participant can compare a score achieved to that of other score participants. For example, a host may keep track of the highest score or scores achieved by queue participants within a selected period of time, and award a prize or prizes to those with the highest score or scores.

In an embodiment of the invention, pagers for use with the system are provided with a contoured, ergonomic shape to facilitate and encourage interactive use by queue participants. In addition, or in the alternative, each pager may be configured for stacking onto other pagers of the same type. When being kept for distribution, such as at a hostess station, a plurality of pagers may thereby be stacked so as to occupy a minimal amount of space. Optionally, each pager may also be configured with electrical contacts so that each pager in the stack may be connected to a battery-charging current source. Each pager may also be provided with circuitry for “smart charging” of its rechargeable batteries, to prolong battery life while maintaining an adequate charge in each pager.

To reduce incidence of loss of pagers, a disposable chit may be issued to participants late in the queue, in lieu of a pager. The chit may be imprinted with a return time for the participant, after which a participant may return to exchange the chit for a pager.

A more complete understanding of the pager and paging system for queue participants will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a plan view showing a front side of an exemplary pager for use with a system or method according to the invention.

FIG. 2 is a view of a reverse side of the exemplary pager shown in FIG. 2.

FIG. 3 is a cross-sectional view of the exemplary pager shown in FIG. 1.

FIG. 4. shows a side view of an exemplary stack of pagers in a stack-charging mode, for use with the invention.

FIG. 5 is a block diagram showing an exemplary system according to the invention.

FIG. 6 is a flow chart showing exemplary steps of a method according to the invention.

### DETAILED DESCRIPTION OF THE PREFERRED EMBODIMENT

The present invention provides a method and system for paging queue participants, that overcomes the limitations of the prior art. In the detailed description that follows, like element numerals are used to describe like elements appearing in one or more of the figures.

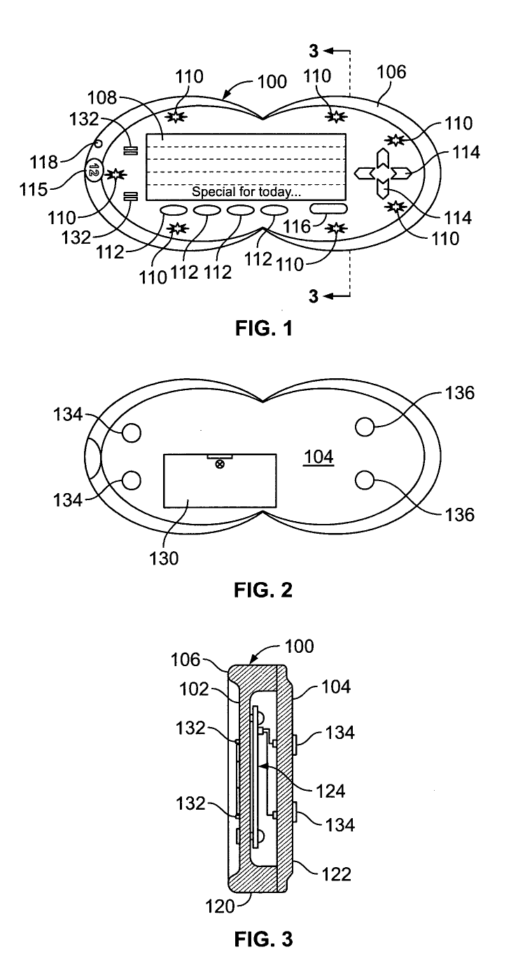

FIG. 1 shows a front side of an exemplary pager 100 for use with a system or method according to the invention. A reverse side of pager 100 is shown in FIG. 2, and a cross-sectional view is shown in FIG. 3. Pager 100 comprises a recessed front panel 102, a reverse face 104, and a lip 106 running around the front face. The foregoing features may be provided in a molded body, which may be comprised of two or more pieces 120, 122 that may be assembled to house an electronic system 124 for the pager. Preferably, the pager body thereby comprises a rugged and moisture-resistant housing for the pager's electronic system.

A display screen 108, such as an LCD display, and a plurality of indicator lights 110 (or in the alternative, a single indicator light) may be disposed in pager 100 and arranged so as to be visible from the front face. Screen 108 may comprise a single-line text display, a multi-line text display, or a graphics display. A multi-line text display may advantageously permit a user of the pager to play text-only games (for example, trivia games), without necessitating the use of an graphics display screen, which may tend to be more expensive.

In addition, pager 100 may be configured so that one or more indicator lights 110 lights up or flashes in a conspicuous and distinctive fashion to indicate that the holder of the pager has reached the head of a queue. In the alternative, or in addition, the pager may be provided with a tone generator and/or a vibrator or buzzer (not shown), for providing an audible and/or tactile signal to the pager holder, as known in the art. Voice paging notification may also be provided, as known in the art. Pager 100 may also be provided with an identification panel 115 bearing an identification number or other identifier. The identifier should be one that is exclusively assigned to the pager 100 in a multi-pager paging system for queue management. The identifier may be conspicuously marked on the pager body to facilitate identification by the paging host.

Additional features that may be provided in pager 100 include one or more control features for receiving input from a user of the pager; for example, scroll buttons 112, selection keys 114, and/or a command key 116. It should be apparent that it may not be necessary or optimal to provide all of the control features shown in FIG. 1, which may, or course, be configured differently than shown. For example, some lesser or greater number of keys may be provided, and/or features other than buttons or keys may be provided. In the alternative, or in addition, display screen 108 may be configured as a touchscreen for accepting user input, and/or the pager may be provided with a microphone and configured for accepting voice-activated commands.

Paging and other electronic functions of the pager 100 may be provided by the electronic system 124, which may comprise a circuit board and electronics of a type suitable for a handheld electronic device. The system should be configured to provide traditional paging functions. For example, the electronic system may be configured with a UHF receiver, and may include a programmable device for receiving and displaying paging signals using any suitable paging format, for example, POCSAG. Using any suitable paging format, the electronic system may be configured to receive various messages from a host for the paging systems. Such messages may include, for example, an indication that the holder of the pager has reached (or is about to reach) the head of a queue; an estimated amount of remaining wait time, and/or any desired advertising or other message. Electronic system 124 may additionally include other features. For example, the electronic system may include a memory holding programmable instructions for one or more games that may be played using the pager.

In an embodiment of the invention, the electronic system is configured to enable a user to play a text-based game, such as a trivia game or word game, using the display screen 108 and interactive controls 112, 114, 116 of the front panel 102. A trivia game may comprise series of text-based questions concerning any desired subject matter. Several alternative answers may be provided for each question, and a user plays the game by selecting the best answer from the alternatives. Points may be awarded based on the number of correct answers out of questions attempted, or in any other desired fashion. Advantageously, text-based games may be provided that require relatively little memory or other resources to store and to play.

The paging system may also be configured to allow other types of game to be played using the paging system. For example, various arcade-style games may be suitable, or may be configured for play using the pager's display and user controls. The invention is not limited to any particular type of electronic game, and it is anticipated that the complexity and interest associated with such games may increase as more advanced microprocessors, displays, and controls become available and economically suited for the intended application.

Games may be configured to operate in a stand-alone mode on the pager, for the amusement of the pager holder. Optionally, a user's score or a highest score or scores for a given pager may be recorded for any desired length of time. In the alternative, or in addition, pagers may be configured for interactive play with other pager holders. For such applications, the electronic system should comprise a transmitter or other suitable communication link for two-way communication with a host site. Such features, and the additional software and hardware resources needed to support them, may add substantial cost to a paging system, and therefore may not be desirable for more cost-sensitive applications.

Electronic functions of the pager units, and in particular, game functions, may be configured to be disabled when the unit is out of range of the host station. This may discourage theft of the pagers. For example, if the host paging signal is not detected, or falls below a defined signal strength, the pager controller may disable game play and display a message such as “OUT OF RANGE” on the pager's display. Optionally, the pager may emit a tone or other signal to indicate that it is out of range. When the paging unit is brought back into range, the controller may automatically restore normal operation of all pager functions, and/or emit a signal to indicate that it is again in communication with the host.

To effectively manage a queue using a paging system with a plurality of pagers, each pager should be rechargeable so as to conveniently maintain an adequate charge. Accordingly, pager 100 may be provided with a battery compartment behind a door 130. The battery compartment may be configured to hold one or more batteries, which may be used to power the electronic system for the pager. Various types of suitable rechargeable batteries are known in the art; for example, Ni—Cd and Nickel metal hydride (Ni-Mh) batteries are available in standard sizes such as “AA” or “AAA,” and may be suitable for use with pager 100. A charging circuit may be used to recharge the batteries when the pager is returned to a hosting station and connected to a power source. The charging circuit may be configured to supply an optimal amount of current to recharge the pager's battery system. Such charging circuits are sometime referred to as “smart” charging circuits or systems, and various suitable embodiments are known in the art. The charging circuit may additionally include an indicator light 118 that lights up when pager 100 is being recharged.

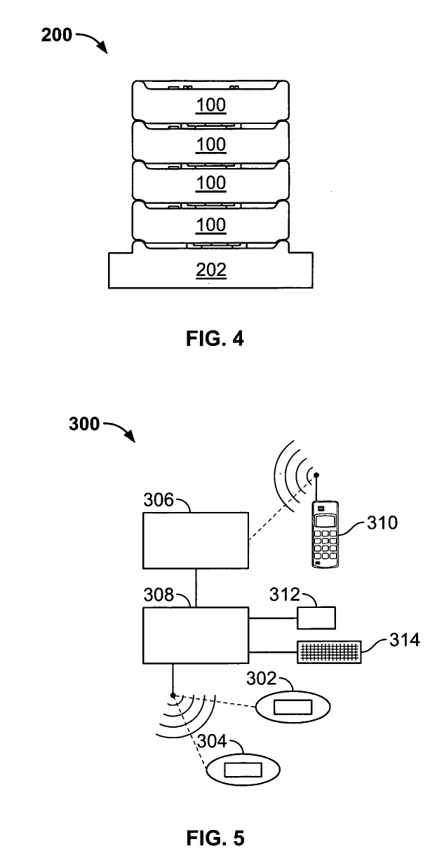

In an embodiment of the invention, a plurality of pagers such as pager 100 may each be configured for charging when stacked. To this end, pager 100 may include one or more electrical contacts 132 on a surface of the pager (such as on front panel 102, as shown), and a second set of contacts 134 on a complementary surface, such as on reverse surface 104. The reverse surface 104 may additionally be provided with one or more stand-offs 136 for positioning of pager 100 when stacked or placed on a flat surface. Either or both of contacts 132, 134 may include a spring loaded element for establishing and maintaining electrical contact, and each one of the contacts 132 is connected to a corresponding one of contacts 134 through the body of the pager. Each pager may be configured so that contacts 132 on its top surface make contact with a corresponding contact 134 on a lower surface of an adjoining pager. A charging current may thereby be provided to a plurality of pagers that are stacked vertically. Preferably, contacts 132, 134, and connecting circuitry in any given pager are configured to safely carry a maximum charging current for a stack of pagers. If so, pagers may be stacked in any desired order. FIG. 4. shows an exemplary stack 200 of pagers 100 in a stack-charging mode, for use with the invention.

A bottom one of pagers 100 may rest in a host charging unit 202, that may be connected to any suitable power source. The charging unit may be used to condition power supplied to each pager. Host unit 202 may additionally provide other connections, for example serial port connections to each of the stacked pagers through a suitable pair of opposing connectors (not shown) on each pager 100. Such other connections may be used to gather data from each pager, and/or to supply the pager with additional or revised games or advertising messages. It may be desirable, however, to omit additional connectivity in order to provide a paging system at a lower cost.

FIG. 5 shows an exemplary paging and queue management system 300 according to the invention. System 300 may comprise a plurality of pagers 302, 304, each one of which may comprise a uniquely-identified pager of a type described herein. System 300 additionally comprises a queue estimator 306 connected to a paging host 308. Queue estimator 306 and paging host 308 may comprise separate devices that are connected by any suitable connection. For example, queue estimator 306 may comprise a general-purpose computer running an application for queue management, connected via a network to a special-purpose paging host device 308. In the alternative, devices 306 and 308 may be implemented as different functions of the same physical device.

The paging host 308 may be configured to wirelessly transmit estimated wait times and other information to respective ones of the plurality of pagers 302, 304. For some applications, it may be desirable for the range of the signal from the paging host to be limited; for example, to less than about one mile, or less than about one-quarter mile. Range may be limited, for example, by configuring transmitter antenna configuration or signal strength, or receiver sensitivity of the pagers so as to create range limits lower than what would otherwise be attainable.

In an embodiment of the invention, queue estimator 306 may comprise a computer running an application, for example, a host management system, that periodically receives input about available system resources and use, and from this information derives an estimated wait time for each position in the queue. For example, estimator 306 may receive current use information from a mobile service provider or host that enters information into a portable wireless device 310. A plurality of such devices may communicate with estimator 306. In the alternative, or in addition, estimator 306 may receive information from any number of input devices through any suitable connection. A suitable device estimator may be known in the art for certain applications. For example, a table service management application, sold under the trademark NTN ProHost® (www.ntnnetwork.com), is capable of providing estimated wait times for restaurant operations. Prohost® may also facilitate generation and transmittal of host-defined messages, such as advertising or informational messages, to the pagers of a host system. If Prohost® is not available or desired, one of ordinary skill may develop suitable software for the intended application. For example, messaging, including but not limited to providing advertising and estimated wait times, can be handled by a small stand-alone application running at a host terminal for the paging system instead of Prohost®.

Estimator 306 may be configured to periodically calculate an estimated wait time for each place in a queue. For example, estimator 306 may communicate with host device 308 to determine the pager identity, resources required (e.g., number of people in the party) and place in line of each queue holder. The estimator 306 may then calculate a wait time estimate for each place in the queue, based on the most current state of available resources. This information may then be provided to the paging host 308 and transmitted to each pager, where it may appear on each pager's display screen. For example, a message could be scrolled on the screen, stating that “Your estimated wait time is 15 minutes.” For further example, a message might state a number of parties remaining in the queue ahead of the receiving party. Updated estimates may be provided at intervals, for example, every five minutes. In addition, each pager may be configured to flash briefly, or to provide some other notification signal, when an estimated wait time is updated and/or revised.

Paging host 308 may additionally comprise a display screen 312 and/or a keypad 314 to permit a host to manually signal or send a message to any selected pager, in additional to transmitting any signals generated automatically by the system 300. The host 308 is connected to a transmitter 316 for transmitting to pagers in the network.

Paging host 308 may be equipped to provide other functions as known in the art, for example, providing an “auto locate” function to assist locating a missing pager. The paging host may additionally be configured to communicate with the pagers for the purpose of game play. For example, trivia questions may be transmitted to pagers in the network, as may other messages, including advertising messages, as previously described. Various systems and methods for communicating with multiple pagers for the purpose of queue management are known in the art. Further details concerning implementing the invention should be apparent to one of ordinary skill in such paging and queue management systems, and need not be described further herein.

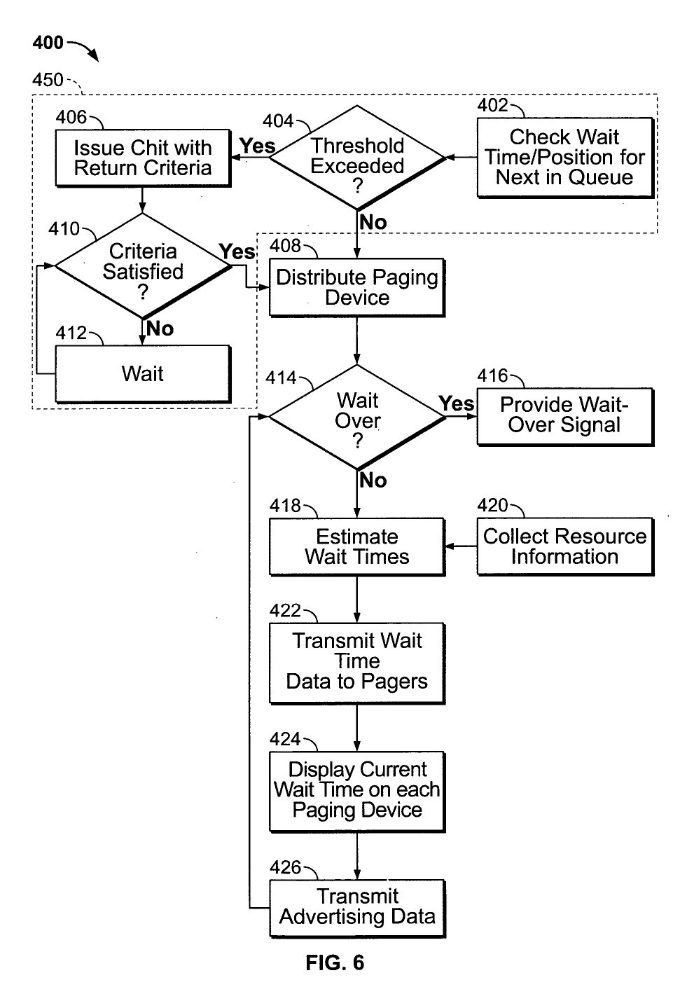

FIG. 6 show an exemplary method 400 for managing a queue for access to a resource, for example, tables or seats at a restaurant using any suitable system as herein described. A chit-issuing process 450, comprising steps 402, 404, 406, 410, and 412, is an optional part of method 400. Process 450 may be useful to reduce incidence of loss of pagers or to handle excess demand which might otherwise be lost because of a shortage of available pagers. At step 402, when a prospective queue participant requests entry into a queue, a host checks a wait time for the next queue position, or simply notes the current highest queue position or that all queue positions for which pagers are available have been already occupied. If, at step 404, any suitable threshold set by the host is exceeded, for example, maximum wait time or queue position, then at step 406, the host issues a chit to the participant in lieu of a pager. If the threshold is not exceeded, then the participant is eligible to receive a pager, which is issued at step 408.

A chit may comprise any small article suitable for bearing a symbol or message. It may be imprinted or otherwise marked with a return time, after which the queue participant may return to receive a pager as herein described. In the alternative, but less preferably, the chit may bear a queue position number which when announced or displayed on a queue board indicates that the participant may return to receive a pager. The chit may comprise a disposable slip such as a piece of paper or plastic, so if the participant elects to leave the queue, the host does not suffer any loss. In the alternative, but less preferably, the chit may comprise any suitable reusable article such as a plastic tile or card.

At step 410, criteria for eligibility to receive a pager—that is, return time or queue position—are tested against the applicable parameters of current time or next eligible queue position. While the applicable criterion is not satisfied, the queue participant waits in the queue at step 412. When the criterion is satisfied, the participant receives a pager at step 408.

In an embodiment of the invention, step 408 may operate as follows. System pagers may be maintained in a stack connected to one or more host stations. The uppermost pager in the stack may be assigned the next queue position when removed from the stack. For example, when a pager is added to the stack, its position in the stack may be determined electronically, and its address or other identifying information communicated to the paging host. When a pager is later removed for distribution to a queue participant, its address or identifying information is assigned to the next open queue position in a queue list maintained by the host. At the same time, information may be gathered concerning the level of resources required by the queue participant. For example, in a restaurant application, each party specifies a number of persons in the party. Such information may maintained together with the queue position to determine when each participant may be served. As the resource is supplied to those in the queue and the pagers are returned to the host station, the list may be updated accordingly.

Step 408 may be continued for as long as it is desired to add new participants to the queue. At step 414, when participant reaches the head of the queue, its wate is over. The host station may transmit a “wait over” signal to the pager, which provides a visual, audible or tactile signal to indicate that the party holding the pager can now be served. The participant holding the pager may return it to the host station, where it is returned to the stack to be used again in step 408 for distribution to the next participant.

For those participants still in the queue, the system estimates a wait time for each queue position, using any suitable algorithm. The estimation algorithm should operate using available data concerning the present status and use of resources. Such data may be collected at step 420 as known in the art. For example, in a restaurant application, tables may be classed into different sizes (e.g., 1-2, 3-4, 4-8, etc.) and the status of each available table updated using information from waitpersons and others. It may be noted, for example, when a table is seated, when the order is taken, when the food arrives, when the check arrives, and when table is cleared. Such information may be used to efficiently manage the restaurant resources, and various systems are known for this purpose.

But in addition, such management information may also be useful in generating accurate estimates of wait times at step 418. Using current status information, a system may track progress of each table to determine an average rate, or individual rates at which each table progresses to completion. An estimate of time remaining may then be made for each table, and the estimates correlated to the queue positions in the queue list based on the queue position and requested resources level (e.g., table size). Then at step 422, data indicating an estimated wait time is provided to each respective pager in the queue. Each pager may then display a message, for example “ONLY TEN MORE MINUTES REMAINING,” using an alpha-numeric or other suitable display, as indicated at step 424. Steps 418-424 should be repeated at periodic intervals while the queue is being maintained, for example, every minute, every two minutes, or at any desired interval. Queue participants may thus be kept informed of the latest estimated time remaining for their turn in the queue.

At step 426, other information may be transmitted at any desired time for display by the pager, for example, advertising information. In a restaurant setting, for example, participants may be advised of daily menu specials or other offers. As described above, the pagers may also be used to play a game. Games may operate independently of the transmitting host station. In the alternative, or in addition, information may be provided from the pager to the host. For example, a host may record scores for game play performed using pagers in the system. Scores from different queue participants may be compared for the purpose of recognizing winners and/or awarding a prize. In an embodiment of the invention, game functions are disabled when the pager is removed from the transmitting range of the paging host station.

Having thus described a preferred embodiment of a paging system for queue participants, it should be apparent to those skilled in the art that certain advantages of the within system have been achieved. It should also be appreciated that various modifications, adaptations, and alternative embodiments thereof may be made within the scope and spirit of the present invention. For example, a paging system configured for game play in a stand-alone mode has been illustrated, but it should be apparent that the inventive concepts described above would be equally applicable to systems designed for group game play, and to systems without any game capability. The invention is defined by the following claims.

1. A system for managing a queue for access to a resource, comprising:
a paging host configured to transmit estimated wait time information determined for respective queue positions of a queue for access to a resource; and
a plurality of pagers each having a communication link to the paging host for transmitting the estimated wait time information, wherein each of the plurality of pagers is assigned to a respective one of the queue positions and configured to display an estimated wait time determined for its assigned queue position.

2. The system of claim 1, further comprising a queue management computer having a communication link to the paging host, the queue management computer configured to receive resource availability information and determine the estimated wait time information.

3. The system of claim 2, wherein the queue management computer is further configured to generate additional messages for display by each of the plurality of pagers.

4. The system of claim 3, wherein the additional messages comprise advertising messages.

5. The system of claim 2, wherein the queue management computer is further configured to periodically update the estimated wait time information.

6. The system of claim 1, wherein each of the plurality of pagers comprises a memory holding instructions for a game, wherein the game is played by operating a display of the pager and receiving input from an input key of the pager.

7. The system of claim 6, wherein the game comprises a question-and-answer game awarding points for correct answers to questions posed on the display.

8. The system of claim 6, wherein the game comprises an arcade-style game awarding points based on a timing or direction value of directional input.

9. The system of claim 6, wherein each of the plurality of pagers is configured such that, if the pager is outside of the limited operating range of the paging host, operation of the game is disabled.

10. The system of claim 1, wherein the signal from the paging host is configured for transmitting the estimated wait times over a limited operating range from the paging host.

11. The system of claim 10, wherein each of the plurality of pagers are configured to provide at least one of an audible, tactile, or visible signal when it is taken outside of the limited operating range.

12. The system of claim 10, wherein each of the plurality of pagers are configured to at least partially disable the pager when it is taken outside of the limited operating range.

13. The system of claim 1, wherein the signal from the paging host is configured for transmitting the estimated wait times over a limited operating range of less than one-quarter mile from the paging host.

14. The system of claim 1, wherein each of the plurality of pagers further comprises a signaling device selected from a light, a vibrating signal, and auditory signal.

15. A method for managing a queue for access to a resource, comprising:
distributing ones of a plurality of wireless communication devices to respective participants in a waiting queue for access to a resource, wherein at least the distributed ones of a plurality of wireless communication devices are correlated to respective queue positions of the queue; and
transmitting wait data to respective ones of the plurality of wireless communication devices, wherein the wait data represents a wait time estimated for each respective queue position.

16. The method of claim 15, further comprising displaying a representation of an estimated wait time for each respective queue position on respective display screens of the plurality of wireless communication devices.

17. The method of claim 15, further comprising activating a signal of a respective one of the plurality of wireless communication devices to signal an end of a waiting period for a respective queue participant.

18. The method of claim 15, further comprising estimating a respective wait time for each respective queue position.

19. The method of claim 18, further comprising repeating the estimating step to provide updated wait data.

20. The method of claim 15, further comprising at least partially disabling at least one of the plurality of wireless communication devices when out of range of a transmitter for transmitting the wait data.

21. The method of claim 15, further comprising transmitting an advertising message to the plurality of wireless communication devices for display on respective display screens thereof.

22. The method of claim 15, further comprising issuing a chit to a queue participant in lieu of distributing one of the plurality of wireless communication devices, the chit bearing at least one of an estimated return time and a queue position.

23. The method of claim 22, wherein the issuing step further comprises issuing the chit as a disposable slip.

24. The method of claim 22, wherein the issuing step is performed if an estimated wait time for a next queue participant exceeds a set period of time.

25. The method of claim 22, further comprising distributing one of the plurality of wireless communication devices to a queue participant holding the chit when the estimated return time is not later than a current time.

26. The method of claim 22, wherein the issuing step is performed if a queue position for a next queue participant exceeds a set number of positions from a head of the queue.

27. The method of claim 22, further comprising distributing one of the plurality of wireless communication devices to a queue participant holding the chit bearing a queue position not greater than a set number of positions from a head of the queue.
